(19) United States
(12) Patent Application Publication
(10) Pub. No.: US 2007/0027594 A1
(43) Pub. Date: Feb. 1, 2007

(54) Dual inlet fuel tank and method of using the same

(76) Inventors: Dean E. McNevich, Hot Springs Village, AR (US); Alexander J. Karnauskas, Willowbrook, IL (US)

Correspondence Address: DEAN E. MCNEVICH, 48 PALMA LANE, HOT SPRINGS VILLAGE, AK, 71909, US

(21) Appl. No.: 10/957,931

(22) Filed: Oct. 4, 2004

(51) Int. Cl. G06F 7/00

(52) U.S. Cl. 701/36; 701/123

(57) ABSTRACT

A dual inlet fuel tank assembly for a vehicle and a method of using the same. The assembly includes at least one fuel tank, a first fuel inlet in fluid communication with the at least one fuel tank, and a second fuel inlet in fluid communication with the at least one fuel tank. A controller is in communication with the fuel tank and the first and second fuel inlets. The method includes providing a first and a second fuel inlet in communication with at least one fuel tank. At least one of the first and second fuel inlets is opened from a closed position. The vehicle is fueled through at least one of the first and second fuel inlets. Each opened fuel inlet is closed. Fuel inlet closure states for the first and second fuel inlets are determined. A safety protocol is initiated based on the determination of the fuel inlet closure states.

### TECHNICAL FIELD OF THE INVENTION

The present invention relates generally to vehicles. More particularly, the invention relates to strategies for refueling a vehicle.

### BACKGROUND OF THE INVENTION

In most vehicles, such as cars, minivans, trucks, and the like, a fuel inlet is usually positioned on either side of the vehicle (e.g., a driver's side or a passenger's side). The inlet provides a point for refueling the vehicle when positioned adjacent to a fuel pump. In the setting of a contemporary fuel station or “gas station”, multiple fuel pumps may be positioned in rows or so-called “islands”. In many instances, a vehicle cannot conveniently access an available fuel pump. For example, the driver may not know or remember on which side of the vehicle the fuel inlet is positioned. Or, if the fuel inlet side is known, fuel stations may have another customer positioned at a desired fuel pump. The driver is then faced with having to either wait for the other customer to finish refueling or maneuver the vehicle, sometimes turning the car about in a small area, to access another fuel pump. This may waste not only the time of the driver, but may reduce the productivity of the fuel station itself. As such, it would be desirable to provide a more convenient strategy for refueling a vehicle.

Once a vehicle has completed fueling, a gas cap is typically reattached to the fuel inlet followed by the closing of a small door covering the gas cap. In some instances, either the gas cap is not reattached and/or the gas door closed. Numerous problems may result from the operation of the vehicle in such an instance. For example, fuel may spill and/or the vehicle may not operate properly. As such, it would be desirable to provide a strategy for ensuring the closure of the fuel inlet after completing fueling.

Therefore, it would be desirable to provide a strategy for fueling a vehicle that overcomes the aforementioned and other disadvantages.

### SUMMARY OF THE INVENTION

A first aspect of the present invention provides a dual inlet fuel tank assembly for a vehicle. The assembly includes at least one fuel tank, a first fuel inlet in fluid communication with the at least one fuel tank, and a second fuel inlet in fluid communication with the at least one fuel tank. A controller is in communication with the fuel tank and the first and second fuel inlets.

A second aspect of the invention provides a method of fueling a vehicle. The method includes providing a first and a second fuel inlet in communication with at least one fuel tank. At least one of the first and second fuel inlets is opened from a closed position. The vehicle is fueled through at least one of the first and second fuel inlets. Each opened fuel inlet is closed. Fuel inlet closure states for the first and second fuel inlets are determined. A safety protocol is initiated based on the determination of the fuel inlet closure states.

A third aspect of the invention provides a dual inlet fuel tank assembly for a vehicle. The assembly includes a first and second fuel inlet in communication with at least one fuel tank. Means are provided for opening at least one of the first and second fuel inlets from a closed position. Means are provided for fueling the vehicle through at least one of the first and second fuel inlets. Means are provided for closing each opened fuel inlet. Means are provided for determining fuel inlet closure states for the first and second fuel inlets. Means are provided for initiating a safety protocol based on the determination of the fuel inlet closure states.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIGS. 1A and 1B are rear and top perspective views, respectively, illustrating a portion of a dual inlet fuel tank assembly for a vehicle in accordance with one embodiment of the present invention;

FIG. 2 is a schematic view of a portion the dual inlet fuel tank assembly for a vehicle in accordance with one embodiment of the present invention;

FIG. 3 is a schematic view of a remote control in accordance with one embodiment the present invention; and

FIG. 4 is a flow chart illustrating a method of fueling a vehicle in accordance with one embodiment of the present invention.

### DESCRIPTION OF THE PRESENTLY PREFERRED EMBODIMENTS

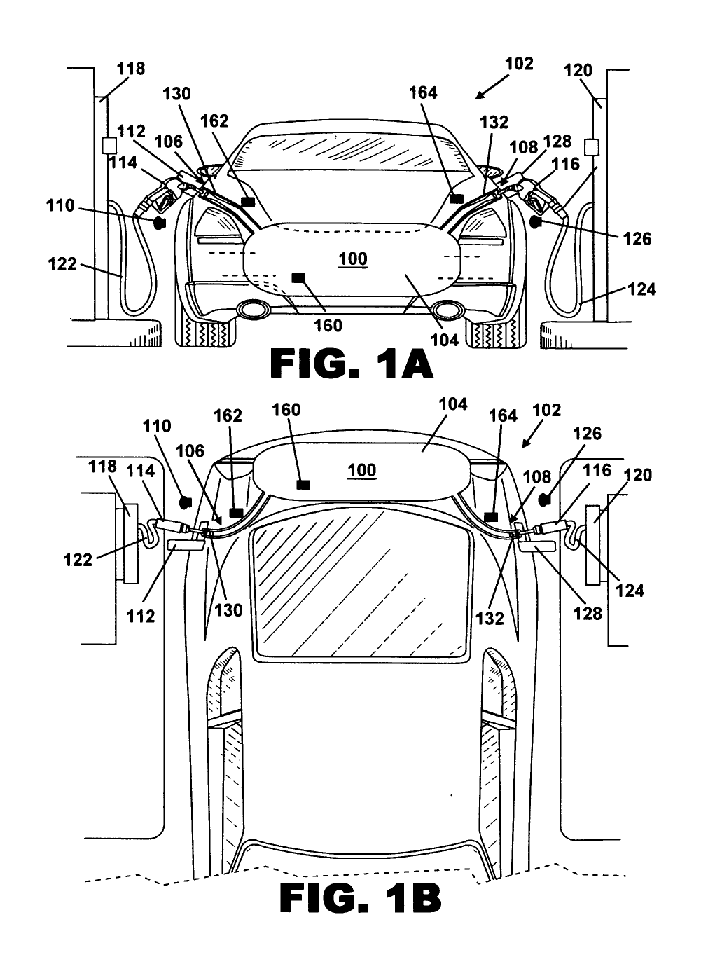

Referring to the drawings, wherein like reference numerals refer to like elements, FIGS. 1A and 1B are rear and top perspective views, respectively, illustrating a portion of a dual inlet fuel tank assembly for a vehicle in accordance with one embodiment of the present invention. The dual inlet fuel tank assembly and the vehicle are shown generally by the numerals 100 and 102, respectively. Those skilled in the art will recognize that the assembly 100 and vehicle 102 may include a number of alternative embodiments and variations. For example, the type of the vehicle 102 may vary and comprise numerous (mini)vans, trucks, buses, motorized transports, and the like. In this case, the vehicle 102 shown and described is an automobile.

In one embodiment, the assembly 100 includes at least one, in this case one, fuel tank 104. A first fuel inlet 106 and a second fuel inlet 108 are in fluid communication with the fuel tank 104. As defined herein, the first and second fuel inlets 106, 108 comprise openings formed within a portion of or an extension of the fuel tank 104. First fuel inlet 106 includes a first fuel cap 110 and a first fuel door 112, which are both shown in an open position. Second fuel inlet 108 includes a second fuel cap 126 and a second fuel door 128, which are both shown in an open position. The open position of the fuel inlets 106, 108 is defined herein as having the corresponding fuel cap 110, 126 and/or fuel door 112, 128 in the open position. A closed position of the fuel inlets 106, 108 is defined herein as having both of the corresponding fuel caps 110, 126 and the fuel doors 112, 128 not in the open position (i.e., when the fuel caps 110, 126 are operably attached to the fuel inlets 106, 108 and the fuel doors 112, 128 are shut).

One or more, in this case one, sensor 160 may be in communication with the fuel tank 104 for determining a fuel fill state. One or more, in this case one, sensor 162, 164 may be in communication with each of the first and second fuel inlets 106, 108 for determining the fuel inlet closure states.

Vehicle 102 is shown and described as being in the process of refueling. Fuel nozzles 114, 116 are positioned within the first and second fuel inlets 106, 108, respectively. Fuel nozzles 114, 116 are coupled to fuel pumps 118, 120, respectively, each via a flexible hose 122, 124. Fuel pumps 118, 120 may vary and may dispense a number of different fuels such as gasoline, hydrogen, and the like depending on the nature and design of the vehicle 102. First and second fuel doors 112, 128 may be operably attached to the vehicle 102 with a hinge-like assembly and opened either manually or automatically (i.e., with a release from within the vehicle, a remote control, etc.).

First and second fuel caps 110, 126 may be removably attached via a threading mechanism, as understood in the art. A one-way check valve 130, 132 may be positioned within the first and second fuel inlets, respectively. One-way check valves 130, 132 are known in the art and generally minimize or prevent backsplash and leakage of fuel from the fuel tank 104. Fuel tank 104 and its associated components may be manufactured from materials known in the art and in accordance with current safety specifications and the type of fuel being used. In another embodiment, at least one additional fuel tank inlet may be provided in addition to the first and second fuel inlets 106, 108. This may provide additional advantages, such as speedier fueling.

In one embodiment, as shown, the first fuel cap and door 110, 112 and the second fuel cap and door 126, 128 may both be in the open position thereby allowing simultaneous fueling from both vehicle 102 sides. In another embodiment, the second fuel cap and door 126, 128 may be in the closed position while the first fuel cap and door 110, 112 are in the open position or vice versa during refueling. When the vehicle 102 is not being fueled, however, the first fuel cap and door 110, 112 and the second fuel cap and door 126, 128 are typically in the closed position. Those skilled in the art should appreciate that the arrangement, design, positioning of the fuel tank 104, first and second fuel inlets 106, 108, and other components may vary from the described and illustrated embodiments.

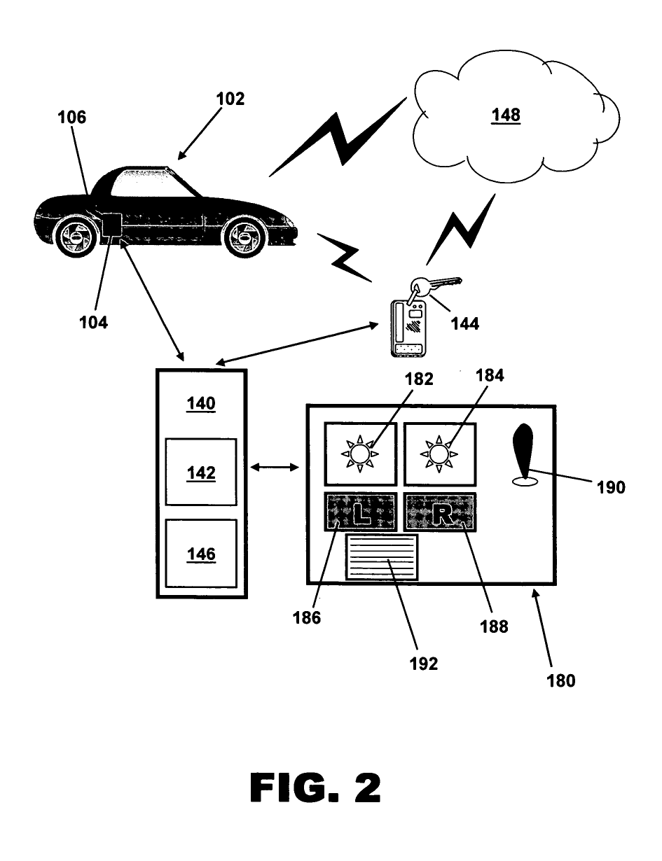

Referring now to FIG. 2, a schematic view of a portion the assembly 100 in accordance with one embodiment of the present invention is shown. Assembly 100 includes a controller 140 positioned within the vehicle 102 and in communication with the fuel tank 104 and the first and second fuel inlets 106, 108. Controller 140 may include a digital microprocessor 142. Controller 140 may be programmed to process a plurality of input signals received from the sensor 160 in communication with the fuel tank 104 and sensors 162, 164 in communication with the first and second fuel inlets 106, 108. The use of such sensors is understood by one skilled in the art. Controller 140 may be in communication with a remote control 144. The computer usable medium including a program for operating the assembly 100 and program code associated with the presently preferred embodiments may be read into and stored in a memory portion 146 (e.g., ROM, RAM, EPROM, EEPROM, and the like) for access by the microprocessor 142, as understood in the art. Furthermore, value tables, variables, parameters, data, and other information may be stored as required in the memory portion 146. Analog signal processing may be provided for some of the input signals received by the controller 140. For example, the information sent from the sensors 160, 162, 164 and remote control 144 may be low-pass filtered through analog filter(s) to reduce signal noise.

Communication between the controller 140, remote control 144, and a communications network 148 may use wireless networking protocols such as IEEE 802.11b and IEEE 802.15 that operate in the 2.4-GHz industrial, scientific and medical (ISM) band. IEEE 802.11b, often referred to as wireless fidelity (Wi-Fi), is a standard commonly used for communication on wireless local area networks (WLAN). Remote control 144 may also use the lower-powered technology of Bluetooth™ or the IEEE 802.15 protocol, a short-range radio standard often employed in wireless personal area networks (WPAN). Bluetooth™ is particularly suited for wireless connections within 10 meters. WiFi and Bluetooth™ technology allow communication between devices located within approximately 10 to 100 meters of one another.

In one embodiment, a display assembly 180 may be in communication with the controller 140. Display assembly 180 may include one or more, in this case two, visual alarms 182, 184, such as lights or LEDs, providing a visual alarm function thereby indicating that the first fuel inlet 106 and/or second fuel inlet 108 is/are in the open position. Display assembly 180 may further include one or more, in this case two, release buttons 186, 188 to automatically unlock and open the first and second fuel doors 112, 128 via the controller 140. An override 190 switch may be provided to disable an ignition kill function. The ignition kill function, as described further below, may disable the vehicle 102 from being started should one or more of the fuel inlets 106, 108 be in the open position. A speaker 192 may provide an audio alarm function alerting the vehicle 102 operator when, for example, one or more fuel inlets are inadvertently left in the open position.

Display assembly 180 may be positioned within the vehicle 102 at a suitable location for communicating information to and in reach of a vehicle 102 operator. In one embodiment, the display assembly 180 may be positioned within a vehicle dashboard. In another embodiment, the display assembly 180 may be integrated within a vehicle steering wheel. In yet another embodiment, various portions of the display assembly 180 may be positioned in different areas of the vehicle 102 (i.e., the release buttons 186, 188 may be positioned on the steering wheel and the audio/visual alarm function portions positioned within the dashboard). Those skilled in the art will recognize that the arrangement, positioning, function, and design of the display assembly 180 may vary. The Inventors contemplate numerous variations of the display assembly 180 in accordance with the present invention.

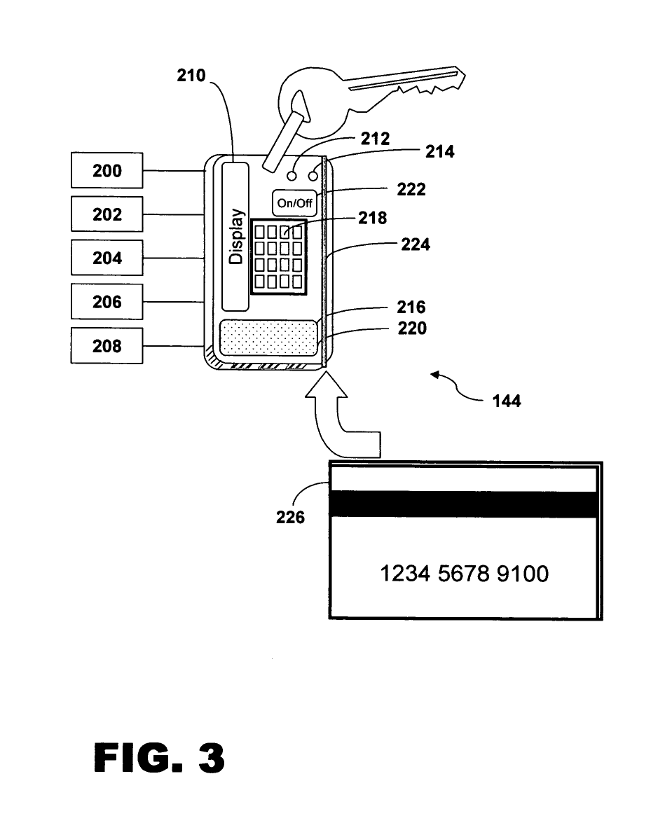

Referring now to FIG. 3, a schematic view of the remote control 144 in accordance with one embodiment the present invention is shown. Remote control 144 is a small hardware device with a size comparable to that of cellular phones or pagers, for example, and dimensions for comfortably fitting into a purse, on a belt, or in a pocket. Remote control 144 may control basic services such as unlocking doors, as well as facilitate higher end services such as defining programmable steering wheel buttons, seat positions, and radio stations. The controller 140 may access information stored in the remote control 144. In one embodiment, the remote control 144 includes memory 200, a controller 202, a transceiver 204, an antenna 206, a battery 208, a display 210, colored LEDs 212, 214, a speaker 216, a microphone 218, a keypad 220, an on/off switch 222, and a magnetic strip reader 224. In other embodiments, the remote control 144 may further include other user interface mechanisms, buttons, displays, features, and the like including increasingly powerful wireless communication devices and voice-recognition capabilities.

Information contained on a magnetic strip card 224, such as a credit card, may be read by the magnetic strip reader 222 and stored into the memory 200. The card 224 information may then be communicated to the controller 140 and further stored in its memory 146 and/or communicated to the communications network 148. In one embodiment, fuel added to the vehicle 102 may be paid for by communicating credit card information automatically from the remote control 144 or the controller 140 to, for example, a fuel service station. Multiple swipes of the card 224 are not required between refueling as the card 224 information may be stored within the remote control 144 or the controller 140. Encryption technology known in the art may protect the integrity of the card 224 information during its storage and transmission. Code data may be entered manually into the keypad 220 for performing various functions such as authorizing a credit card (i.e., by entering a pin number), opening of the fuel inlets 106, 108, overriding the ignition kill function, etc.

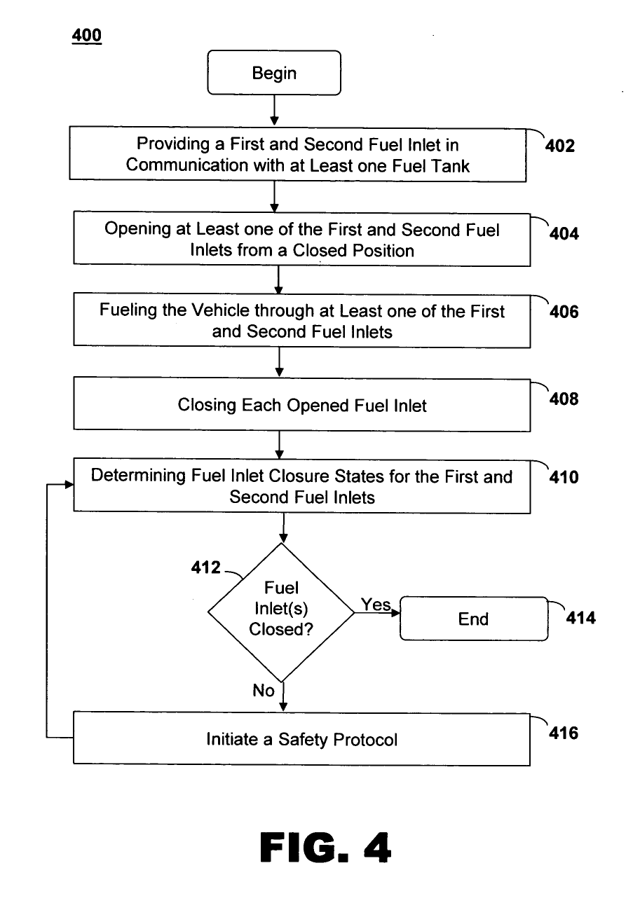

Referring now to FIG. 4, a flow chart 400 illustrates a method of fueling a vehicle 102 in accordance with one embodiment of the present invention. The method may begin by providing first and second fuel inlets 106, 108 in communication with at least one fuel tank 104 (step 402). Fuel caps 110, 126 and fuel doors 112, 128 may be operably attached to the first and second fuel inlets 106, 108 thereby preventing fuel from leaking from the fuel tank 104. Once it is deemed by the vehicle 102 operator that refueling is required, the vehicle 102 may be driven adjacent a fuel pump positioned on either side of the vehicle 102. The present invention spares the vehicle 102 operator from having to determine which side of the vehicle the fuel inlet is located. Further, the vehicle 102 operator does not have to maneuver (e.g., turn around in a confined area) the vehicle 102 to position it appropriately next to the fuel pump or, in some cases, wait in a line. Once properly positioned next to the fuel pump, the vehicle 102 operator may shut off the ignition. Shutting off the ignition provides a measure a safety as well as reduces vehicle emissions.

At least one of the first and second fuel inlets 106, 108 is opened from a closed position (step 404). In one embodiment, one or both of the first and second fuel inlet(s) 106, 108 may be opened by depressing corresponding release button(s) 186, 188 to automatically release (i.e., unlock) and open the first and/or second fuel door(s) 112, 128. This may be followed by unscrewing the corresponding fuel cap(s) 110, 126 manually. In another or the same embodiment, the first and second fuel doors 112, 128 may be automatically released and opened by remote control 144. In another or the same embodiment, the first and second fuel doors 112, 128 may be manually opened and, optionally, include a lock and key. Those skilled in the art will recognize that the design of the first and second fuel inlet 106, 108 may vary. As such, the strategy for opening and closing the first and second fuel inlet 106, 108 may vary as well. The Inventors contemplate that many such designs and strategies may be adapted for use with the present invention.

The vehicle is fueled through at least one of the first and second fuel inlets (step 406). The provision of the first and second fuel inlets 106, 108 on either side of the vehicle 102 allows easy access for refueling. In many instances, the vehicle 102 operator will choose a side for convenience and will refuel using only one of the fuel inlets 106, 108. In some instances and for some vehicles, however, it may be desirable to refuel a vehicle using both fuel inlets. The sensor 160 may provide the vehicle 102 operator with real-time feedback as to the fill state of the fuel tank 104. The fill state information may be communicated to the display assembly 180, remote control 144, or by other means and by audio and/or visual means. The determination of a fuel tank fill state using one or more sensors is known in the art.

Each opened fuel inlet is then closed (step 408). Once refueling is completed, the appropriate fuel cap(s) 110, 126 and fuel door(s) 112, 128 may be closed to seal the opened fuel inlet(s) 106, 108.

Fuel inlet closure states for the first and second fuel inlets 106, 108 are determined (step 410). Sensors 162, 164 in communication (i.e., operably coupled) to the fuel inlets 106, 108 may sense open fuel cap(s) 110, 126 and/or fuel door(s) 112, 128. Should all of the fuel inlets 106, 108 be determined to be in the closed position (step 412), the method may terminate (step 414). The vehicle 102 may be then started and operated.

Should one or more fuel inlets 106, 108 be determined to be in an open position (step 412), a safety protocol is initiated (step 416). The safety protocol may include providing audio and/or visual alarm functions to the vehicle 102 operator through the display assembly 180 and/or the remote control 144. Further, the controller 140 may communicate with a vehicle ignition system and activate the ignition kill function, as understood in the art, thereby preventing the vehicle 102 from being started while one or more fuel inlet(s) 106, 108 are in the open position. The vehicle 102 operator (or another person), alerted to the situation, may then close the fuel inlet(s) 106, 108. Once the fuel inlets 106, 108 are closed, the sensors 162, 164 may determine that this is so (step 410) and the method may terminate (step 414). The vehicle 102 may be then started and operated.

While the embodiments of the invention disclosed herein are presently considered to be preferred, various changes and modifications can be made without departing from the spirit and scope of the invention. For example, the dual inlet fuel tank assembly and the method of fueling a vehicle are not limited to any particular design, configuration, sequence, or arrangement. The vehicle, fuel tank, fuel inlets, fuel caps, fuel doors, controller, sensors, and remote control configuration, size, shape, geometry, location, orientation, number, and function may vary without limiting the utility of the invention. Furthermore, the methods and algorithms according to the present invention may be accomplished by numerous alternative strategies, equations, formula, and the like, and may include additional steps, and vary in step order.

Upon reading the specification and reviewing the drawings hereof, it will become immediately obvious to those skilled in the art that myriad other embodiments of the present invention are possible, and that such embodiments are contemplated and fall within the scope of the presently claimed invention. The scope of the invention is indicated in the appended claims, and all changes that come within the meaning and range of equivalents are intended to be embraced therein.

1. A dual inlet fuel tank assembly for a vehicle, the assembly comprising:
at least one fuel tank;
a first fuel inlet in fluid communication with the at least one fuel tank;
a second fuel inlet in fluid communication with the at least one fuel tank;
a controller in communication with the fuel tank and the first and second fuel inlets; and
an ignition kill override in communication with the controller.

2. The assembly of claim 1 wherein the first fuel inlet comprises a first fuel cap and a first fuel door, and the second fuel inlet comprises a second fuel cap and a second fuel door.

3. The assembly of claim 1 wherein the controller comprises a computer usable medium including a program for operating the dual fuel inlet tank assembly, the computer usable medium comprising:
computer readable program code for determining a fuel inlet closure state; and
computer readable program code for initiating a safety protocol based on the fuel inlet closure state.

4. The assembly of claim 3 wherein the safety protocol comprises computer readable program code for performing at least one of an audio alarm function, a visual alarm function, and an ignition kill function.

5. The assembly of claim 3 further comprising computer readable program code for determining a fuel tank fill state.

6. The assembly of claim 1 further comprising a remote control in communication with the controller.

7. The assembly of claim 6 wherein the remote control comprises at least one or more features including a memory, a controller, a transceiver, an antenna, a battery, a display, at least one LED, a speaker, a microphone, a keypad, an on-off switch, a magnetic strip reader.

8. The assembly of claim 1 further comprising a display assembly in communication with the controller.

9. (canceled)

10. The assembly of claim 1 further comprising at least one additional fuel tank inlet in fluid communication with the fuel tank.

11. The assembly of claim 1 further comprising at least one sensor in communication with the first fuel inlet and the controller, and at least one sensor in communication with the second fuel inlet and the controller; wherein the sensors determine fuel inlet closure states.

12. A method of fueling a vehicle, the method comprising:
providing a first and a second fuel inlet in communication with at least one fuel tank;
opening at least one of the first and second fuel inlets from a closed position;
fueling the vehicle through at least one of the first and second fuel inlets;
closing each opened fuel inlet;
determining fuel inlet closure states for the first and second fuel inlets;
initiating a safety protocol based on the determination of the fuel inlet closure states; and
providing a safety protocol override through a controller.

13. The method of claim 12 wherein the safety protocol comprises at least one protocol selected from a group consisting of an audio alarm function, a visual alarm function, and an ignition kill function.

14. The method of claim 12 wherein the first fuel inlet comprises a first fuel cap and a first fuel door, and the second fuel inlet comprises a second fuel cap and a second fuel door.

15. The method of claim 12 further comprising determining a fuel tank fill state.

16. The method of claim 12 further comprising communicating information between a controller and a remote control.

17. The method of claim 16 wherein the information is selected from a group consisting of audio information, visual information, keypad information, magnetic strip information, and code data.

18. The method of claim 16 wherein the information is transmitted over a communications network.

19. (canceled)

20. A dual inlet fuel assembly for a vehicle, the assembly comprising:
a first and second fuel inlet in communication with at least one fuel tank;
means for opening at least one of the first and second fuel inlets from a closed position;
means for fueling the vehicle through at least one of the first and second fuel inlets;
means for closing each opened fuel inlet;
means for determining fuel inlet closure states for the first and second fuel inlets;
means for initiating a safety protocol based on the determination of the fuel inlet closure states; and
means for providing a safety protocol override through a controller.
